(19) United States
(12) Patent Application Publication
(10) Pub. No.: US 2019/0292055 A1
(43) Pub. Date: Sep. 26, 2019

(54) Phosphorus Pentoxide Production Methods and Systems with Fluorine Management

(71) Applicant: JDCPhosphate, Inc., Fort Meade, FL (US)

(72) Inventors: David B. Blake, Lakeland, FL (US); Sourabh A. Pachpor, Lakeland, FL (US); Mark Vignovic, Lakeland, FL (US)

(21) Appl. No.: 16/358,504

(22) Filed: Mar. 19, 2019

Related U.S. Application Data
(60) Provisional application No. 62/645,632, filed on Mar. 20, 2018.

(51) Int. Cl. C01B 25/12; C10B 1/10

(52) U.S. Cl. CPC C01B 25/12; C10B 1/10

(57) ABSTRACT

Phosphorus pentoxide production with fluorine management includes collecting phosphorus from kiln off gas as phosphoric acid containing fluorine and reacting the fluorine in the phosphoric acid with reactive silica to yield fluorosilicic acid. The fluorosilicic acid is removed from the collected phosphoric acid. Fluorine management includes discharging from the kiln a residue containing processed agglomerates and heating the discharged, processed agglomerates and releasing fluorine therefrom. The released fluorine is reacted with reactive silica to yield fluorosilicic acid and the fluorosilicic acid is collected. Fluorine management includes forming a reducing kiln bed with feed agglomerates below a reducing freeboard. Kiln off gas is generated containing phosphorus in the form of elemental phosphorus a) oxidized outside of the kiln to phosphorus pentoxide and collected as phosphoric acid, b) collected as elemental phosphorus, or c) both.

### CROSS REFERENCE TO RELATED APPLICATIONS

This application claims the benefit of priority under 35 U.S.C. § 119 to U.S. Provisional Patent Application No. 62/645,632, filed on Mar. 20, 2018 and entitled “Production of Phosphoric Acid”, which is incorporated herein by reference.

### BACKGROUND

U.S. Pat. Nos. 7,378,070, 7,910,080, 8,734,749, and 9,783,419 are incorporated herein by reference as containing background technical descriptions of processes improved by the methods and systems described herein.

One known method for producing phosphorus pentoxide (P₂O₅, usually present as the dimer P₄O₁₀ in the gas phase) involves processing raw material agglomerates containing phosphate ore, silica, and coke in the bed of a rotary kiln to chemically reduce the phosphate ore and generate gaseous phosphorus metal (P₄) and carbon monoxide (CO) off gas to the kiln freeboard where they are burned (oxidized) with air to provide heat for the process. It may be referred to as the kiln phosphoric acid (KPA) process. The oxidized phosphorus metal is a phosphorus oxide (normally, P₄O₁₀) which can be scrubbed from the kiln off gases with a phosphoric acid (H₃PO₄) solution and water to make a suitable phosphoric acid product. The Improved Hard Process (IHP) provides several advancements to the KPA. Despite the advancements described in the incorporated patents relative to the IHP, laboratory evaluation of IHP methods and systems and their implementation in a demonstration plant revealed that further changes, such as those described herein, would be advantageous.

### BRIEF DESCRIPTION OF THE DRAWINGS

Some embodiments are described below with reference to the following accompanying drawings. All percentages designated in the drawings are in weight percent. Acid concentration is indicated in the drawings as % P₂O₅, as is practiced in the art, but may be multiplied by 1.381 to obtain % H₃PO₄, corresponding to the molecular formula for phosphoric acid.

FIG. 1 is a chart showing % fluorine evolution during P₂O₅ scrubbing and concentration.

FIG. 2 is a chart showing % fluorine removal in acid during concentration of P₂O₅ along with diatomaceous earth addition.

FIG. 3 is a chart showing controlled P₂O₅ concentration and % fluorine reduction by addition of diatomaceous earth, heat and agitation.

FIG. 4 is a chart showing % fluorine retention in feed pellets during carbo-thermal reduction of feed mixture at various feed particle sizes for phosphate ore.

FIG. 5 is a chart showing % phosphorus yield during carbo-thermal reduction at different temperatures and residence times for coarse and fine grind sizes for phosphate ore contained in feed material.

FIG. 6 is a cross-sectional view of an exhaust gas oxidizer system for a carbo-thermal reduction kiln.

FIG. 7 is a piping and instrumentation diagram of selected components in a product acid concentration and de-fluorination system.

FIG. 8 is a block flow diagram of a phosphorus pentoxide production system with fluorine management according to some embodiments.

FIGS. 9-15 are block flow diagrams of interconnected unit operations that may be included in a system for pyro-processing phosphate ore to manufacture phosphoric acid by carbo-thermal reduction.

FIG. 16 is a block flow diagram of a fluorosilic acid recovery system that may be included in the phosphorus pentoxide production system according to some embodiments.

### DETAILED DESCRIPTION

All percentages designated herein are in weight percent, unless otherwise indicated. Acid concentration is indicated herein as % P₂O₅, as is practiced in the art, but may be multiplied by 1.381 to obtain % H₃PO₄, corresponding to the molecular formula for phosphoric acid.

De-Fluorination.

Recent laboratory tests indicate that fluorine gas evolves from the phosphate ore pellets during the Improved Hard Process (IHP) induration process (U.S. Pat. No. 9,783,419) as well as during the carbo-thermal reduction process (U.S. Pat. Nos. 7,378,070, 7,910,080, 8,734,749, and 9,783,419). These processes are described more fully in the four incorporated patents listed above. Although it is well known that bed temperature in a rotary kiln and the residence time of material in the kiln greatly affect de-fluorination, these lab tests also demonstrate that the amount of fluorine gas evolved is proportional to the particle size of the pellets.

The laboratory experiments were conducted to determine how to control fluorine evolution from the pellets while increasing the phosphorus yield. The operating parameters for these experiments were:

1) Maintain a constant mix ratio for the IHP pellet for petroleum coke, ground silica, ground phosphate ore, and bentonite.

2) Achieve >90% phosphorus yield for the IHP.

3) Vary the particle size of ground phosphate ore from 80% −325 Mesh to 80% −180 Mesh while maintaining the ground silica and ground petroleum coke particle size at 80% −200 Mesh.

Initial observations and conclusions from these experiments included:

1) Fluorine evolves during the induration and reduction of pellets.

2) Finer particle size for ground phosphate ore reduces the amount of fluorine evolved.

3) Up to 10% of the total fluorine contained in the phosphate ore (fluorapatite) evolves during induration of feed mixture pellets at 1100° C. for 30 minutes when the ore was ground to 80% −325 Mesh (best case scenario).

4) Additional 20% fluorine evolves during the carbo-thermal reduction of the feed mixture pellets. This fluorine is a part of the reduction kiln exhaust gas stream, which is subsequently scrubbed to produce phosphoric acid.

5) Percentage of fluorine evolved increases rapidly at temperature exceeding 1300° C.

6) Fluorine in the form of hydrogen fluoride is highly corrosive and causes iron, chrome and nickel from 316L stainless steel process equipment to leach into the phosphoric acid at concentration ratios equal to the ratios of these metals in the stainless steel.

These initial observations lead to further testing of the phosphoric acid that was produced during previous production trials at a demonstration plant implementing the IHP. These laboratory tests indicated the presence of fluorine and elevated levels of iron, chromium and nickel as impurities in the previously produced acid that was manufactured by scrubbing the P₄O₁₀ gas evolved from the reduction kiln.

During the carbo-thermal reduction of feed pellets, fluorine evolved along with P₂O₅ and was scrubbed along with P₂O₅ in the acid plant. The concentration of fluorine in scrubbing liquid (water) increased along with the increase in concentration of P₂O₅ due to recirculation in the hydration tower (hydrator) and subsequent scrubbing system.

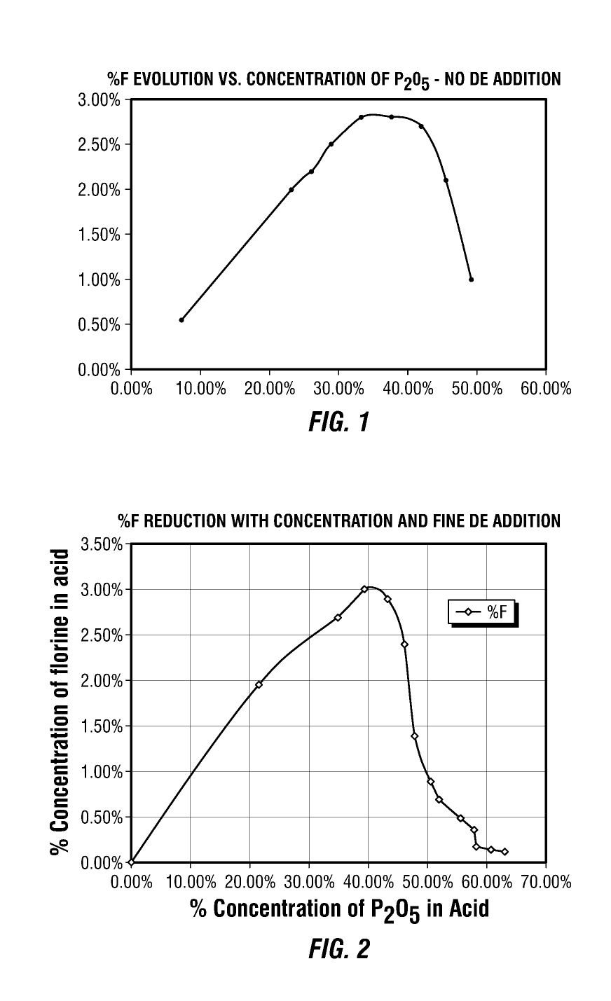

As seen in FIG. 1, the fluorine starts evolving out of the liquid in the form of HF as the P₂O₅ concentration increases over 40%. This HF reacted with the stainless steel scrubbing equipment leeching iron, chromium and nickel from the steel and resulted in discoloration of the acid, the addition of metal impurities in the acid, and accelerated deterioration of process equipment.

Due to these findings, the process flow sheet for the acid plant in the IHP demonstration plant was modified. The material of construction for phosphoric acid scrubbing system was changed from 316L to AL-6XN super-austenitic stainless steel, which is resistant to HF corrosion. The new findings created a desire for a separate acid de-fluorination system for the IHP.

Several processes are currently used for de-fluorinating phosphoric acid manufactured using the Wet Acid Process (WAP).

Current fluorine removal technologies used in the industry include:

1) Evaporation

2) Steam stripping

3) Air Stripping

4) Membrane

One possible de-fluorination method for IHP acid is evaporation. This method strips out the fluorine from the phosphoric acid by using a forced circulation evaporator. The phosphoric acid is mixed with diatomaceous earth (DE) in a mix tank, pumped through the evaporator and back to the tank until the desired phosphorus/fluorine ratio or the allowable level of % fluorine is achieved. The known de-fluorination process has been modified to be integrated as part of the IHP acid scrubbing system.

Laboratory experiments were conducted to evaluate the de-fluorination process. Observations and conclusions from these experiments included:

1) 1% by weight reactive silica (diatomaceous earth) was used to remove fluorine from the phosphoric acid solution (1 part Si per 4 parts F⁻ ion were used).

2) Finely ground DE at 20 μm particle size reacts with hydrogen fluoride (HF) to form fluorosilicic acid (FSA) with application of heat and agitation.

3) The conversion of HF to FSA and its removal from phosphoric acid solution in the form of vapors happens faster at phosphoric acid concentration of 40-45% as P₂O₅.

4) With the application of heat, the phosphoric acid concentrates to desired 68% strength along with de-fluorination.

5) Reduction of fluorine concentration in IHP phosphoric acid to <0.3% can be achieved using this method.

6) The fluorosilicic acid vapors can either be scrubbed separately to manufacture fluorosilicic acid solution or neutralized using NaOH scrubbing.

During the production of phosphoric acid in the IHP demonstration acid plant, the P₄O₁₀ gas from reduction kiln exhaust gas was scrubbed in the Hydrator to make H₃PO₄. The fluorine gas present in the reduction kiln exhaust gas was also scrubbed in the same liquid stream forming HF which resulted in the corrosion of the stainless steel vessels and equipment in the IHP demonstration plant.

For the revised IHP acid plant that produces the acid supplied to the de-fluorination system, the strong acid concentration may be monitored and controlled to 40-45% strength. This acid contains up to 1.5-2% fluorine in the form of HF.

The known WAP de-fluorination systems described above require dilution of the 54% WAP phosphoric acid using water to lower the acid concentration. By controlling the strong acid concentrations to 40-45% during the IHP acid scrubbing process, the dilution step required for the WAP during de-fluorination can be avoided.

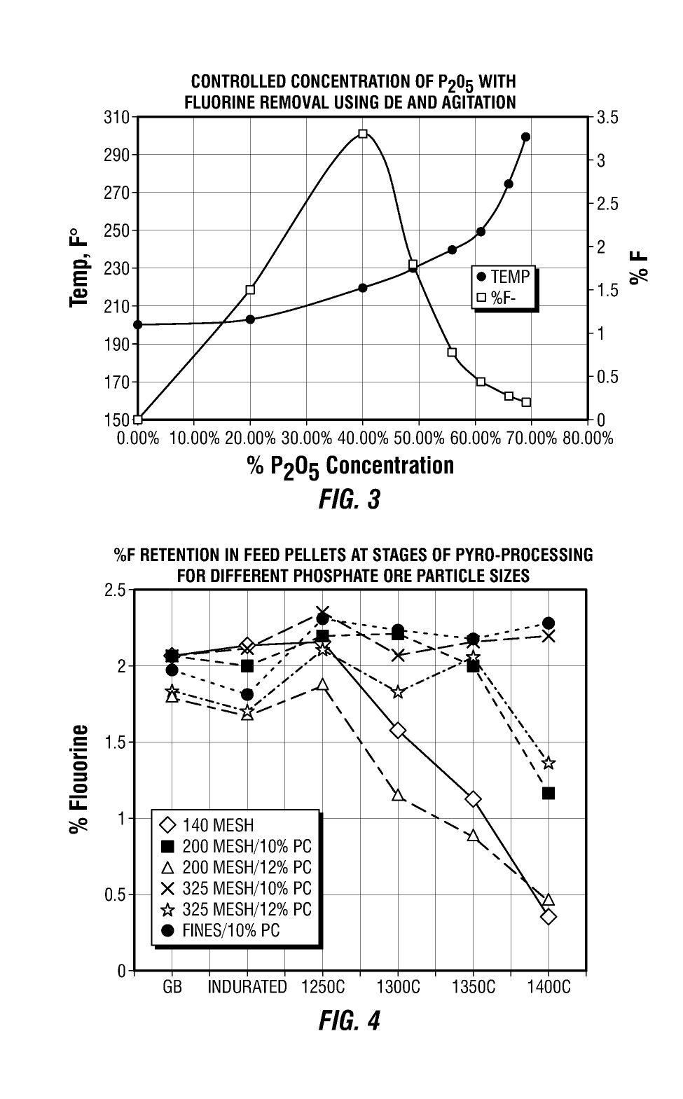

This phosphoric acid from the IHP scrubbing system may be transferred to the de-fluorination system for fluorine removal and acid concentration by evaporation of water. FIGS. 2 and 3 show that addition of fine diatomaceous earth (reactive silica) to the product acid between concentrations of 40-45% P₂O₅ with agitation results in the conversion of HF to fluorosilicic acid (FSA). An amount of reactive silica great than the stoichiometric amount (1:4 Si:F⁻) could be used, but filtration of excess silica from de-fluorinated and concentrated phosphoric acid may be needed. At least 80% of silica particles may have a size less than 20 microns (80% −20 microns) to mix well and react quickly with fluorine in the phosphoric acid. A coarser particle size distribution could be used and still provide some fluorine removal, though an equivalent level of removal is expected to require more silica and a longer reaction time. The FSA vapors can then be removed from the concentration tank with heat and by maintaining slight negative pressure of −0.1 inches of water column (in. WC) gauge pressure or less, such as −0.1 to −0.2 in. WC. These FSA vapors can either be neutralized using NaOH or scrubbed using water to make FSA liquid.

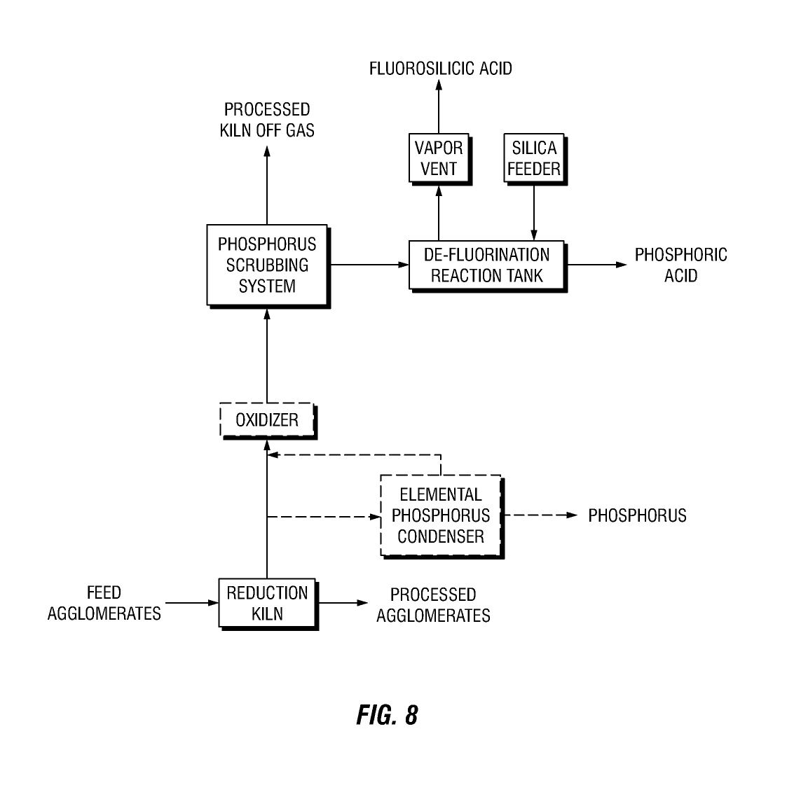

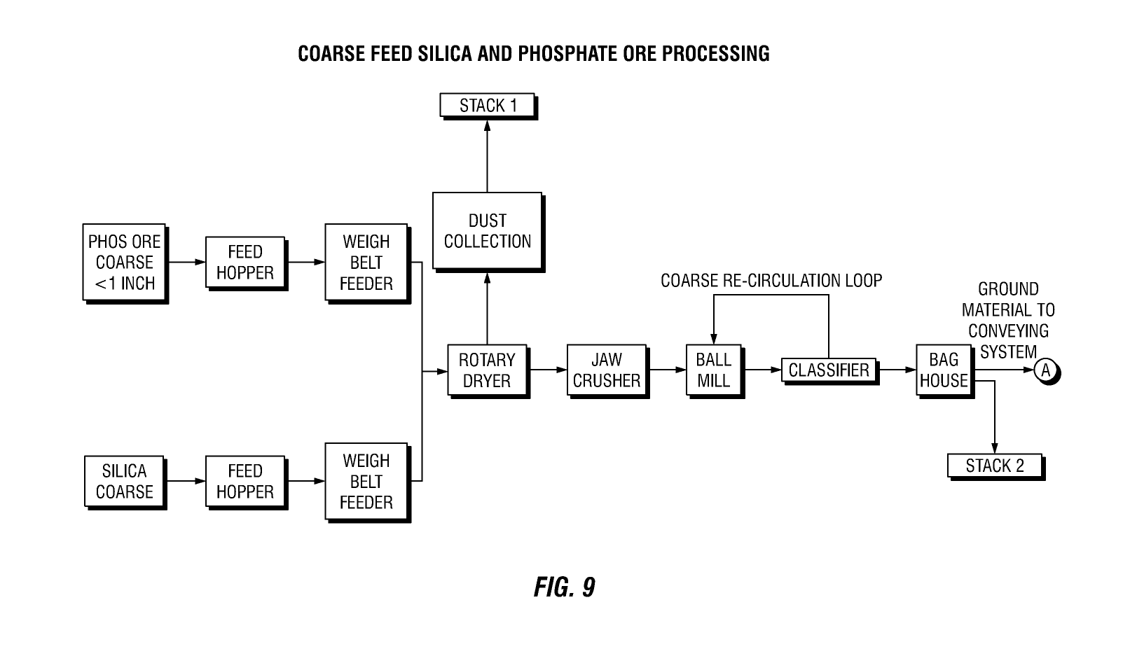

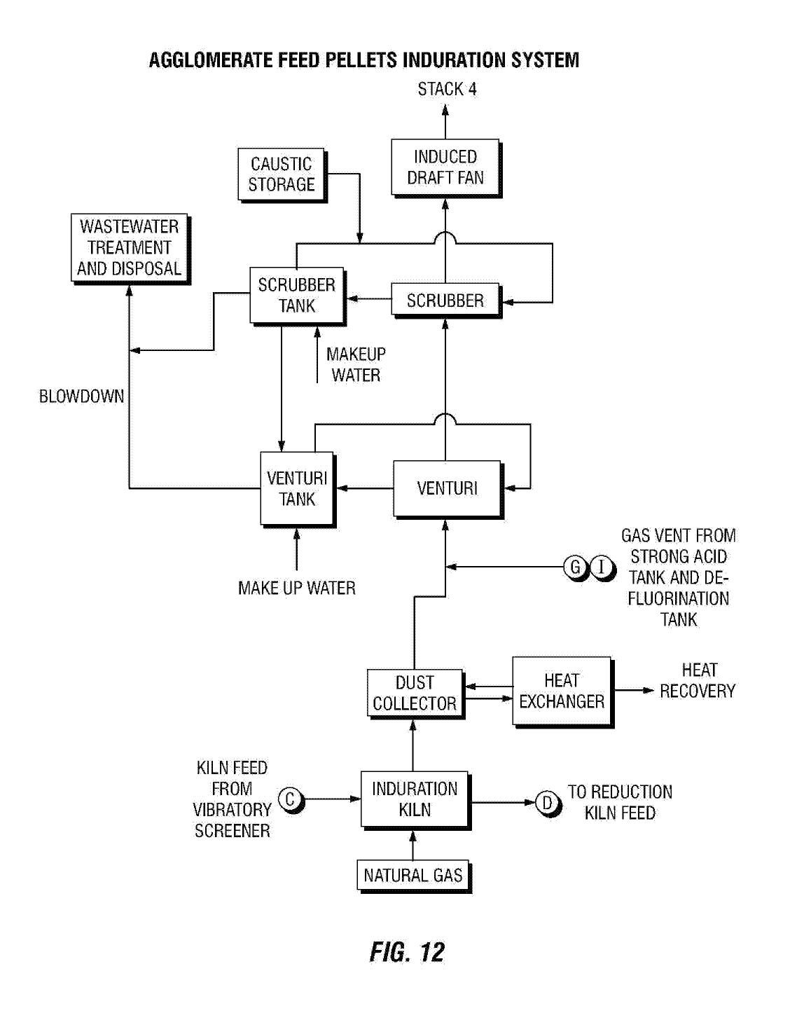

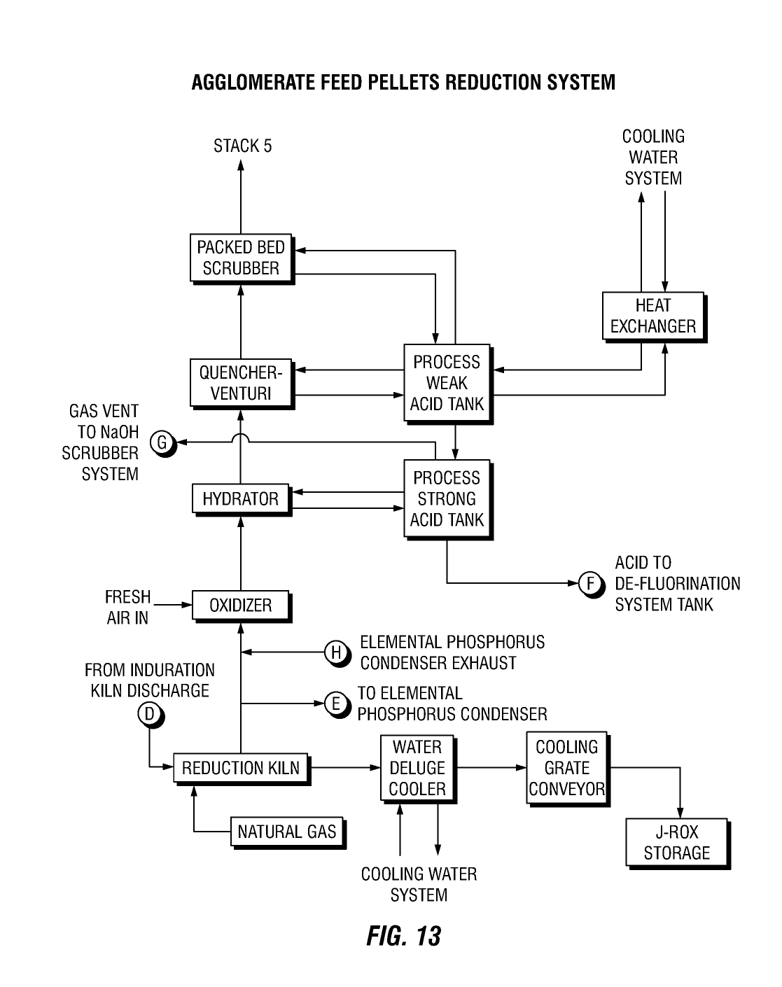

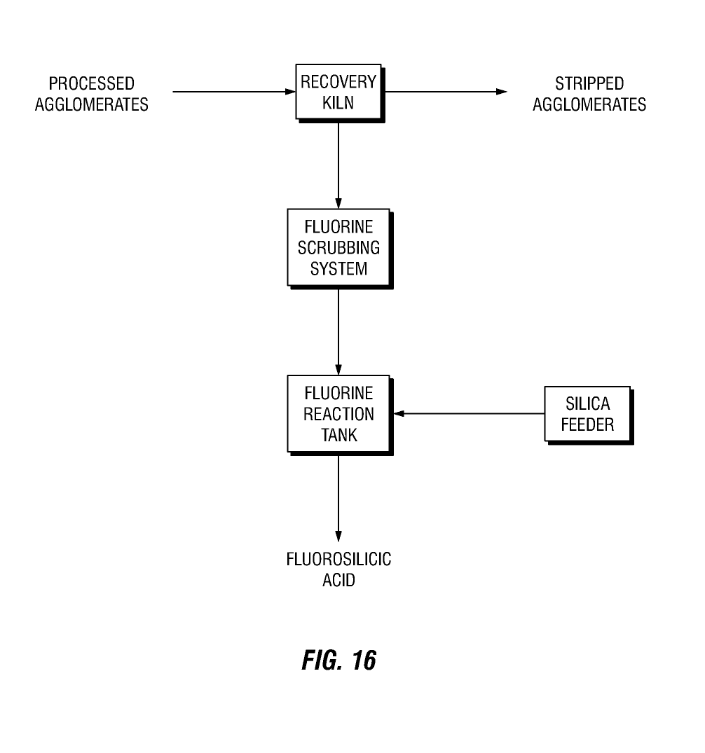

FIG. 8 shows one example of a phosphorus pentoxide production system with fluorine management. A rotary reduction kiln receives feed agglomerates prepared in advance to form a kiln bed. Feed agglomerates may be prepared in a system such as shown in FIGS. 9-11 or in a different system. Feed agglomerates could also be indurated in the system of FIG. 12 or another system, such as those of U.S. Pat. No. 9,783,419. The reduction kiln supplies kiln off gas to a phosphorus scrubbing system that processes kiln off gas to produce phosphoric acid. Processed agglomerates may be discarded or further processed as shown in FIG. 13 or 16 or as known from the four patents incorporated herein. A de-fluorination reaction tank in a de-fluorination system receives the phosphoric acid, which contains fluorine. The de-fluorination system includes a silica feeder that adds reactive silica, such as diatomaceous earth, to the de-fluorination reaction tank, which produces FSA via a vapor vent from the de-fluorination reaction tank and produces phosphoric acid with reduced fluorine content. Additional components of the system are discussed below in subsequent sections regarding the oxidizer system and production of elemental phosphorus.

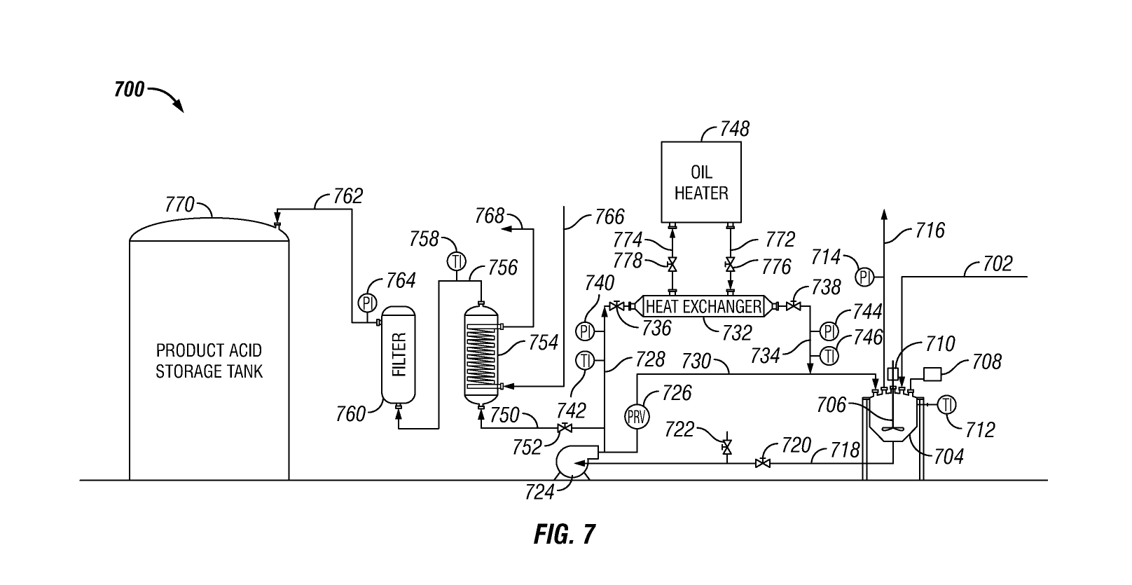

FIG. 7 shows a de-fluorination system 700. A phosphoric acid inlet 702 provides phosphoric acid containing fluorine to a reaction tank 704 including an agitator 706 actuated by a motor 710, a diatomaceous earth feeder 708, and an FSA vapor vent 716. A temperature indicator 712 displays temperature in reaction tank 704 and a pressure indicator 714 displays pressure in FSA vapor vent 716. In a continuous process, as opposed to a batch process, pump 724 removes de-fluorinated and concentrated phosphoric acid from reaction tank 704 via pump suction line 718 and recirculates a part through heat exchanger 732 to provide heat to reaction tank 704. Another part is removed to a product acid storage tank 770. A valve 720 allows isolation of reaction tank 704 from pump 724 and/or flow rate control. A sample port 722 allows testing de-fluorinated and concentrated phosphoric acid for fluorine content, phosphoric acid content, and other constituents and physical properties. A pressure relief valve 726 allows return of de-fluorinated, concentrated phosphoric acid to reaction tank 704 via a pressure relief line 730 in the event that the main return loop via heat exchanger 732 must be isolated or becomes plugged.

A pump discharge line 728 feeds heat exchanger 732 and a temperature indicator 742 and a pressure indicator 740 display process conditions in the feed. A tank return line 734 returns heated acid to reaction tank 704 and a temperature indicator 746 and a pressure indicator 744 display process conditions in the returned acid. Valves 736 and 738 allow isolation of heat exchanger 732, such as for maintenance. An oil heater 748 supplies a heat source to heat exchanger 732 via heater supply line 772 and recirculates cooled oil via heater inlet line 774. Oil heater 748 may be isolated with valves 776 and 778. The FIG. 7 configuration shows one example of controlling temperature and pressure in reaction tank 704 to provide the process conditions desired to achieve removal of the fluorine and concentration of the phosphoric acid.

A side stream of de-fluorinated and concentrated phosphoric acid is removed from pump discharge line 728 by an exchanger inlet line 750 to a cooling exchanger 754. A valve 752 allows isolation of cooling exchanger 754 and/or control of flow rate. A cooling water inlet 766 provides a heat removal medium, which exits cooling exchanger 754 via hot water return 768. An exchanger discharge line 756 feeds a filter 760. A temperature indicator 758 evidences the cooling effectiveness for cooling exchanger 754. A filter 760 removes impurities and a filter discharge line 762 supplies de-fluorinated, concentrated phosphoric acid to product acid storage tank 770. A pressure indicator 764 displays pressure in the filter discharge.

In one embodiment, a phosphorus pentoxide production method with fluorine management includes forming a reducing kiln bed with feed agglomerates in a counter-current rotary kiln. The agglomerates contain phosphate ore particles, carbonaceous material particles, and silica particles. Kiln off gas is generated containing fluorine and phosphorus, the phosphorus being in the form of elemental phosphorus and/or phosphorus pentoxide. The method includes collecting the phosphorus from the kiln off gas as phosphoric acid containing fluorine and reacting the fluorine in the phosphoric acid with reactive silica to yield fluorosilicic acid. The fluorosilicic acid is removed from the collected phosphoric acid.

Additional features may be implemented in the present method. By way of example, the phosphoric acid may be at 40-45% strength (as P₂O₅) when provided for the reaction of fluorine with reactive silica. The reaction of the fluorine may include combining and agitating the phosphoric acid containing fluorine and the reactive silica in a de-fluorination reaction tank. The removal of the fluorosilicic acid may include heating the contents of the tank during the agitation. The method may further include the reacting, agitating, and heating causing release of fluorosilic acid vapor from the phosphoric acid and evaporation of water from the phosphoric acid, which concentrates the phosphoric acid to greater than 45% strength (as P₂O₅). For example, the acid may be concentrated to 68% or greater, such as to 68 to 70%.

In one embodiment, a phosphorus pentoxide production system with fluorine management includes a rotary reduction kiln configured to provide a kiln bed of feed agglomerates flowing counter-current to a kiln freeboard and to produce kiln off gas containing reduction products from the kiln bed. A phosphorus scrubbing system is configured to receive the kiln off gas and to produce phosphoric acid. A de-fluorination system is configured to receive phosphoric acid from the phosphorus scrubbing system and to remove fluorine. The de-fluorination system includes a de-fluorination reaction tank, a silica feeder configured to add reactive silica to the de-fluorination reaction tank, and a fluorosilicic acid vapor vent from the de-fluorination reaction tank.

Additional features may be implemented in the present system. By way of example, when the agglomerates contain phosphate ore particles, carbonaceous material particles, and silica particles, the reduction kiln generates kiln off gas containing fluorine and phosphorus. The phosphorus is in the form of elemental phosphorus and/or phosphorus pentoxide. When the kiln off gas contains fluorine and phosphorus pentoxide, the scrubbing system collects the phosphorus pentoxide from the kiln off gas as phosphoric acid containing fluorine. When the phosphoric acid and reactive silica are reacted in the de-fluorination reaction tank, the fluorine is removed as fluorosilicic acid vapor via the vent.

The additional features that may be implemented in the present method and system may also be implemented in other embodiments herein.

Fluorosilicic Acid Recovery System.

During laboratory tests, it was also observed that up to 80% of the available fluorine from the ore could be evolved by raising the pellet temperature to 1350°-1400° C.

The 20% fluorine released during carbo-thermal reduction of phosphorus and additional 60% fluorine from the J-ROX® reduced pellets produced from the IHP can be recovered and scrubbed to manufacture fluorosilicic acid. This step may include additional pyro-processing of pellets discharged from the reduction kiln in a third kiln and a separate fluorosilicic acid scrubbing system.

Analysis of the IHP feed pellet indicates 1.5-1.7% fluorine content. For every 10 parts of phosphorus, there is 1.5 parts of fluorine available in the IHP feed mixture for removal and recovery.

FIG. 16 shows one example of a fluorosilicic acid recovery system. The FSA recovery system could be incorporated into the system of FIGS. 9-15 or another system, such as the systems described in the four patents incorporated herein. A recovery kiln allows further heating of processed agglomerates after phosphate reduction and removal of phosphorus. In the absence of carbo-thermal reduction, recovery kiln freeboard could be either oxidizing or reducing. The additional heating removes additional fluorine at temperatures higher than experienced during carbo-thermal reduction due to the temperature constraints of the reduction reaction (see four patents incorporated herein). The recovery kiln supplies kiln off gas to a fluorine scrubbing system for removal of fluorine. Separate fluorine scrubbers similar to those described herein for collection of phosphorus may be used. A fluorine reaction tank receives scrubbing system effluent containing HF and combines it with reactive silica, such as diatomaceous earth, from a silica feeder to produce FSA.

In one embodiment, a phosphorus pentoxide production method with fluorine management includes forming a reducing kiln bed with feed agglomerates in a counter-current rotary kiln. The agglomerates contain phosphate ore particles, carbonaceous material particles, and silica particles. Kiln off gas is generated containing fluorine and phosphorus, the phosphorus being in the form of elemental phosphorus and/or phosphorus pentoxide. The method includes discharging from the kiln a residue containing processed agglomerates and heating the discharged, processed agglomerates and releasing fluorine therefrom. The released fluorine is reacted with reactive silica to yield fluorosilicic acid and the fluorosilicic acid is collected.

Additional features may be implemented in the present method. By way of example, the heating of the discharged, processed agglomerates may include heating to a temperature from 1300° to 1400° C., such as from 1350° to 1400° C., and maintaining the temperature for at least 20 minutes, such as 20 to 60 minutes.

The additional features that may be implemented in the present method may also be implemented in other embodiments herein.

Oxidizer System for Phosphorus Gas.

During previous production trials conducted at the IHP demonstration plant, a single, ported rotary kiln was used for the reduction of a fluorapatite ore mixture to evolve phosphorus gas. The phosphorus gas was oxidized in the kiln freeboard to phosphorus pentoxide (P₄O₁₀) for scrubbing to phosphoric acid (H₃PO₄) in the hydrator. During these production trials, it was observed that the P₄O₁₀ gas back-reacted with available calcium from the dust that arose due to attrition of the feed pellets. This reduced the overall process yield and formed calcium phosphate deposits on the feed end of the kiln as well as on the feed pellets as they passed through the kiln.

To achieve the reducing-oxidizing reactions, tertiary air ports were utilized in the rotary kiln. Feed material was fed counter-current to the fuel gas/exhaust gas flow. The burner end of the rotary kiln operated under reducing conditions while the phosphorus gas in the freeboard was oxidized by adding fresh air (oxygen) through the tertiary air ports located at the product feed/hot freeboard gas exhaust end.

JDC proposes a new method that separates the reduction and oxidation stages that occur in the reduction kiln. The reduction kiln may operate under reducing conditions only (stoichiometric) and avoid oxidation. The elemental phosphorus gas does not readily react with available calcium in the absence of free oxygen. By maintaining fully reducing conditions (i.e. no oxygen) in the reduction kiln freeboard and leaving the phosphorus in its elemental form, the chance for the formation of phosphorus pentoxide and the back-reaction of phosphorus pentoxide with calcium present in the attrition dust from the feed pellets is decreased and subsequent process yield losses decreased.

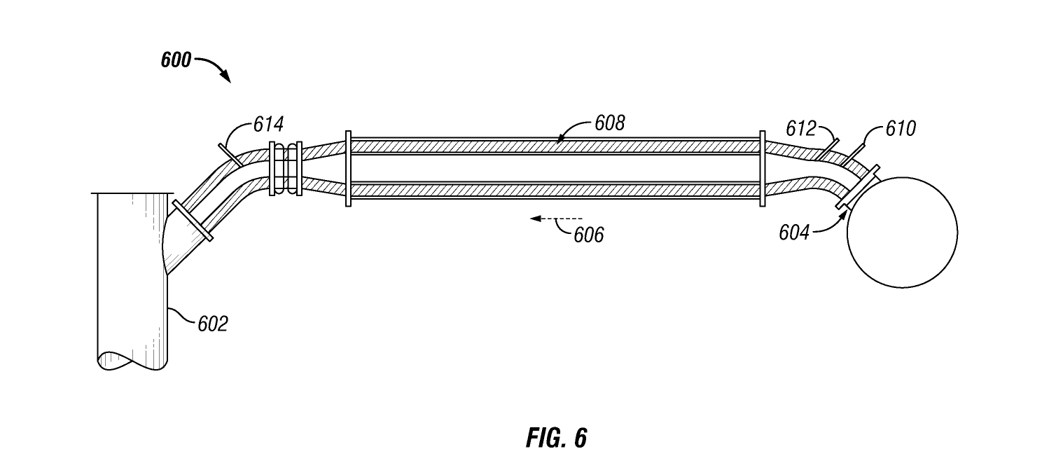

The elemental phosphorus gas may exit the reduction kiln and pass through a stand-alone oxidizer (such as shown in FIG. 6), which may be installed as an intermediate step between the reduction kiln exhaust duct and hydration tower.

Instrumentation for measuring oxygen level may be installed at the feed and discharge end of the oxidizer. The desired oxygen level at the feed end of the oxidizer is 0.0% to show that the reduction kiln is operating in a reducing atmosphere. The desired oxygen level at the discharge end of the oxidizer is >1.0% to ensure that enough oxygen was introduced in the oxidizer to oxidize all available elemental phosphorus in the reduction kiln off gas stream to phosphorus pentoxide.

Metered air (oxygen) may be introduced in the oxidizer to convert elemental phosphorus gas into P₂O₅/P₄O₁₀, which readily reacts with water to form H₃PO₄. Phosphorus burns spontaneously in the presence of oxygen to form phosphorus pentoxide gas. This reaction is exothermic and raises the temperature of the exhaust gas. The temperature of kiln exhaust gas passing through the oxidizer is expected rise to around 2450° F. (1343° C.). This gas stream may then be scrubbed in the IHP hydration tower to manufacture phosphoric acid.

FIG. 6 shows one example of a reduction kiln oxidizer system 600. An exhaust duct 604 from a carbo-thermal reduction kiln supplies oxidizer system 600 with elemental phosphorus to create a gas flow direction 606 though oxidizer 600. A supply duct 602 to a hydration tower delivers the oxidized phosphorus for subsequent processing. A high temperature refractory lining 608 withstands the increased temperatures expected in oxidizer 600. A kiln exhaust oxygen sensor 610 checks control of the kiln at the desired oxygen level. An oxidizer discharge oxygen sensor 614 checks control of oxidizer 600 at the desired oxygen level as allowed by a metered oxygen inlet 612.

FIG. 8 shows incorporation of an oxidizer into one system, when desired, as represented with dashed lines. FIG. 13 shows incorporation of an oxidizer into another system. Oxidizer system 600 may be used in either system.

In one embodiment, a phosphorus pentoxide production method with fluorine management includes forming a reducing kiln bed with feed agglomerates below a reducing freeboard in a counter-current rotary kiln. The agglomerates contain phosphate ore particles, carbonaceous material particles, and silica particles. Kiln off gas is generated containing phosphorus in the form of elemental phosphorus. The method includes oxidizing elemental phosphorus outside of the kiln to phosphorus pentoxide and collecting the phosphorus pentoxide as phosphoric acid.

Additional features may be implemented in the present method. By way of example, approximately all phosphorus contained in the kiln off gas may be in the form of elemental phosphorus. As the term is used herein, “approximately all” refers to a circumstance in which trace amounts of phosphorus might not be in the form of elemental phosphorus, as those of skill in the technology may expect for a complex industrial process. The method may include controlling composition of the reducing freeboard such that the kiln off gas entering the oxidizer contains less than 0.05% oxygen. The method may include controlling the operation of the oxidizer such that the kiln off gas exiting the oxidizer contains greater than 1.0% oxygen.

Production of Elemental Phosphorus.

The carbo-thermal reduction of phosphatic feed pellets produces an exhaust gas that contains elemental phosphorus, carbon monoxide, trace amounts of fluorine compounds and other gases. Elemental phosphorus in exhaust gas is generally in the form of gaseous phosphorus metal (P₄). This reaction may be performed under reducing conditions to avoid any oxidation of phosphorus gas.

The exhaust gas passes through a phosphorus condenser in which chilled water sprays are used to condense elemental phosphorus. This water is drained to a condensate recirculation tank, passes through a chiller unit and is returned to the condenser. The exhaust gas from the condenser contains some remaining phosphorus along with carbon monoxide and trace amounts of fluorine compounds.

Solid phosphorus precipitates in the condensate liquid stream, settles in a condensate drain tank and/or a recirculation tank, and are periodically removed to a phosphorus decant tank where they are removed and stored as elemental phosphorus product. Condensate water that collects in the decant tank is pumped to a condensate water treatment system. The acidic liquid condensate contains fluorine in the form of HF, which can be converted to FSA or neutralized in a subsequent process step. The liquid level in the condensate tank or recirculation tank is maintained by adding fresh water as needed.

The residual phosphorus gas and carbon monoxide from the phosphorus condenser are oxidized in an oxidizer by the introduction of oxygen to form phosphorus pentoxide and carbon dioxide gases. Elemental phosphorus gas auto ignites in presence of oxygen providing the ignition source and heat for combustion of carbon monoxide. A small quantity of natural gas may have to be introduced along with oxygen in the oxidizer to compensate for heat losses occurring in the elemental phosphorus condenser.

The oxidized phosphorus is then scrubbed in the secondary scrubbing system to form phosphoric acid while carbon dioxide gas is released to the atmosphere through the exhaust stack. The solid elemental phosphorus can be further purified or converted to phosphoric acid.

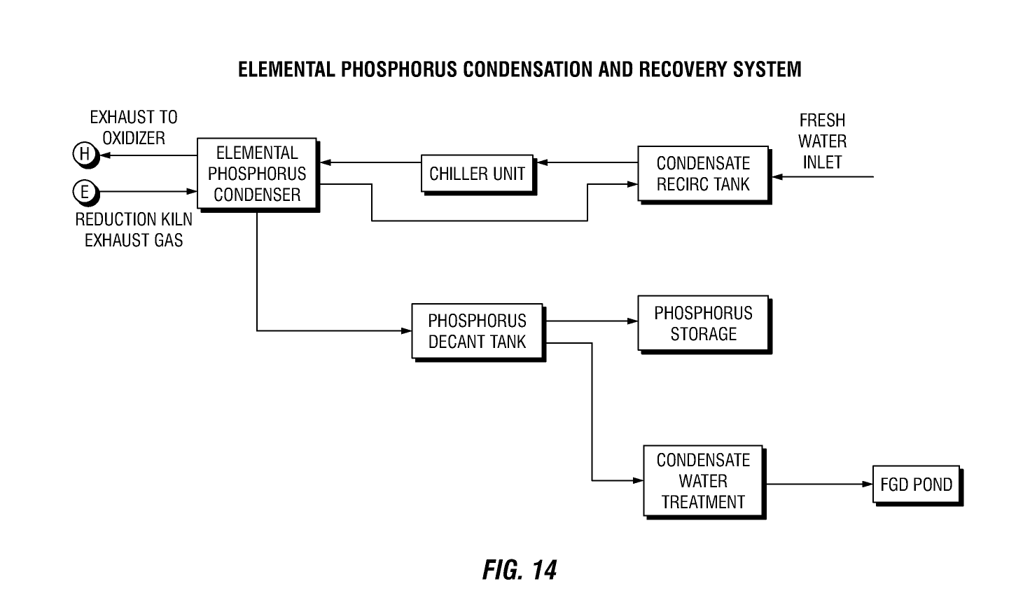

FIG. 8 shows incorporation of an elemental phosphorus condenser into one system, when desired, as represented with dashed lines. FIG. 14 shows incorporation of an elemental phosphorus condenser into another system. Additional components of the elemental phosphorus condensation system in FIG. 14 may be added along with the elemental phosphorus condenser in FIG. 8.

In one embodiment, a phosphorus pentoxide production method with fluorine management includes forming a reducing kiln bed with feed agglomerates below a reducing freeboard in a counter-current rotary kiln. The agglomerates containing phosphate ore particles, carbonaceous material particles, and silica particles. Kiln off gas is generated containing phosphorus in the form of elemental phosphorus. The method includes collecting elemental phosphorus from the kiln off gas as elemental phosphorus.

Additional features may be implemented in the present method. By way of example, approximately all phosphorus contained in the kiln off gas may be in the form of elemental phosphorus.

The additional features that may be implemented in the present method may also be implemented in other embodiments herein.

Fluorine Evolution Control During Reduction Process.

The percentage of fluorine retention during the pyro-processing of feed mixture pellets is dependent on:

1) Particle size of phosphate ore in the feed mixture.

2) % Petroleum coke by weight in feed mixture.

3) Reduction kiln operating temperature.

FIG. 4 summarizes the data collected when feed pellets, made from a mixture of phosphate ore ground at different particle sizes, silica, and petroleum coke, were reduced in a laboratory furnace. From the various data plots presented on the figure, it is evident that a coarser phosphate ore feed mix particle size results in a higher percentage of fluorine evolution when the kiln operating temperature is above 1250° C. It was also observed that addition of petroleum coke at a by weight ratio greater than what is required for the stoichiometric reduction of phosphate by carbon results in higher percentage of fluorine evolution.

This data is helpful in controlling fluorine evolution during the carbo-thermal reduction of phosphate ore for manufacturing phosphoric acid. Controlling the percentage fluorine evolution during the reduction of feed pellets reduces the cost of purification and de-fluorination of acid manufactured. The data can also be used to increase the fluorine evolution for manufacturing fluorosilicic acid (FSA) as a co-product.

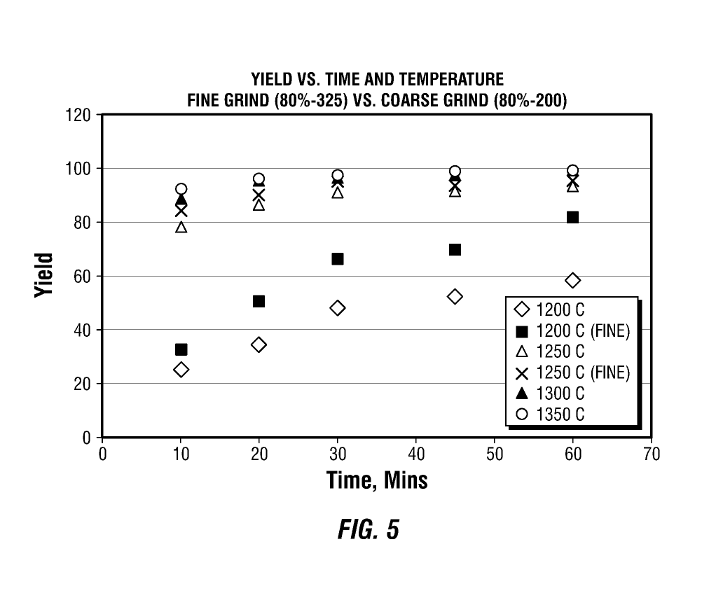

FIG. 5 summarizes the data collected when feed pellets, made from a mixture of phosphate ore, silica, and petroleum coke ground at different particle sizes, were reduced in a laboratory furnace. From the various data plots presented on the figure, it is evident that the finer feed mix particle size (80% −325 Mesh) results in higher than 90% phosphorus evolution during the reduction of feed pellets at kiln operating temperature between 1250° C. and 1350° C.

It is evident from data summarized in FIG. 4 that grind size for ore affects fluorine evolution. At a kiln operating temperature above 1250° C., a higher percentage of fluorine evolution occurs during the reduction of feed pellets made using a coarser ore feed mix at 80% −200 mesh (at least 80% of ore particles had a size less than 74 microns, i.e. passed through a 200 mesh screen). A significant decrease in fluorine evolution was observed for ore feed mix pellets made using a finer ore feed mix at 80% −325 mesh (at least 80% of ore particles had a size less than 44 microns, i.e. passed through a 325 mesh screen).

Data summarized in FIG. 4 also shows that a higher percentage of fluorine evolution occurs during the reduction of feed pellets with the addition of finely ground petroleum coke at a by weight ratio greater than what is required for the stoichiometric reduction of phosphate by carbon. This was observed for both the 200 mesh (74 microns) and 325 mesh (44 microns) ore particle sizes.

Data summarized in FIG. 5 shows that overall higher % of phosphorus evolution yield occurs from the finer feed mix pellets (at least 80% of ore particles having a size less than 44 microns, i.e. passes through a 325 mesh screen) at lower kiln operating temperatures and lower residence time when compared to % of phosphorus evolution yield from coarser feed mix pellets (at least 80% of ore particles having a size less than 74 microns, i.e. passes through a 200 mesh screen).

Collectively the data summarized in FIG. 4 and FIG. 5 help in concluding that fluorine evolution from feed mix pellets during reduction of feed mix can be controlled by controlling the ore feed mix grind size, % petroleum coke, reduction temperature, and residence time while maintaining the overall % of phosphorus yield.

Integration

The preceding paragraphs describe various methods and systems that provide fluorine management in phosphorus pentoxide production methods and systems. Most of the preceding paragraphs focus individually on the various methods and systems. However, the various methods and systems are capable of integration, often with synergistic effects.

As one example, features from the various methods and systems herein may be integrated in the method that involves de-fluorination, namely, reacting the fluorine in the phosphoric acid with reactive silica to yield fluorosilicic acid.

In one integration, the feed agglomerates in the reducing kiln bed may be below a reducing freeboard and the phosphorus in the kiln off gas may be in the form of elemental phosphorus. As such, the method may further include either a) oxidizing elemental phosphorus outside of the kiln to phosphorus pentoxide, wherein the collecting of the phosphorus from the kiln off gas comprises collecting the phosphorus pentoxide as phosphoric acid containing fluorine, or b) collecting elemental phosphorus from the kiln off gas as elemental phosphorus in addition to the collecting of the phosphorus from the kiln off gas as phosphoric acid containing fluorine, or c) both a) and b). Approximately all phosphorus contained in the kiln off gas may be in the form of elemental phosphorus.

When the feed agglomerates in the reducing kiln bed are below a reducing freeboard and the phosphorus in the kiln off gas is in the form of elemental phosphorus, the method may further include oxidizing elemental phosphorus outside of the kiln to phosphorus pentoxide. The collecting of the phosphorus from the kiln off gas may include collecting the phosphorus pentoxide as phosphoric acid containing fluorine.

When the feed agglomerates in the reducing kiln bed are below a reducing freeboard and the phosphorus in the kiln off gas is in the form of elemental phosphorus, the method may further include collecting elemental phosphorus from the kiln off gas as elemental phosphorus in addition to the collecting of the phosphorus from the kiln off gas as phosphoric acid containing fluorine.

When the feed agglomerates in the reducing kiln bed are below a reducing freeboard and the phosphorus in the kiln off gas is in the form of elemental phosphorus, the method may further include oxidizing elemental phosphorus outside of the kiln to phosphorus pentoxide. The collecting of the phosphorus from the kiln off gas may include collecting the phosphorus pentoxide as phosphoric acid containing fluorine. The method may still further include collecting elemental phosphorus from the kiln off gas as elemental phosphorus in addition to the collecting of the phosphorus from the kiln off gas as phosphoric acid containing fluorine.

In another integration, the method may further include discharging from the kiln a residue containing processed agglomerates and heating the discharged, processed agglomerates and releasing fluorine therefrom. Separate from the reacting of the fluorine from the reducing kiln off gas, the released fluorine is reacted with reactive silica to yield additional fluorosilicic acid and the additional fluorosilicic acid is collected.

In a further integration, the method may further include forming the feed agglomerates with phosphate ore particles at least 80% of which have a particle size less than 325 mesh. The feed agglomerates may be formed with a mass of carbonaceous material particles that provides no more than the approximate theoretical carbon requirement for reduction of all phosphate in the ore.

The additional features that may be implemented in the present method may also be implemented in other embodiments herein.

As one example, features from the various methods and systems herein may be integrated in the system that includes a de-fluorination system configured to receive phosphoric acid from the phosphorus scrubbing system and to remove fluorine.

In one integration, the system further includes an oxidizer outside of the reduction kiln configured to receive and to oxidize elemental phosphorus from the kiln off gas. An elemental phosphorus condenser is configured to receive and to collect elemental phosphorus from the kiln off gas and to provide uncollected elemental phosphorus to the oxidizer.

In another integration, the system further includes a fluorine recovery kiln configured to receive a residue containing processed agglomerates discharged from the reduction kiln and to produce kiln off gas containing released fluorine. A fluorine scrubbing system is configured to receive released fluorine and to produce hydrofluoric acid. A fluorine conversion system is separate from the de-fluorination system and is configured to receive hydrofluoric acid from the fluorine scrubbing system and to produce fluorosilicic acid, the fluorine conversion system including a fluorine reaction tank and a silica feeder configured to add reactive silica to the fluorine reaction tank.

The additional features that may be implemented in the present system may also be implemented in other embodiments herein.

As one example, the methods and systems involving oxidizing elemental phosphorus outside of the kiln may be combined with methods and systems involving collecting elemental phosphorus from the kiln off gas. Also, the various methods and systems herein may be integrated in either one of the two methods or in the combination thereof.

In one integration, a phosphorus pentoxide production method with fluorine management includes forming a reducing kiln bed with feed agglomerates below a reducing freeboard in a counter-current rotary kiln. The agglomerates contain phosphate ore particles, carbonaceous material particles, and silica particles. Kiln off gas is generated containing phosphorus in the form of elemental phosphorus. The method includes either, a) oxidizing elemental phosphorus outside of the kiln to phosphorus pentoxide and collecting the phosphorus pentoxide as phosphoric acid, or b) collecting elemental phosphorus from the kiln off gas as elemental phosphorus, or c) both a) and b).

Additional features may be implemented in the present method. By way of example, approximately all phosphorus contained in the kiln off gas may be in the form of elemental phosphorus.

In another integration, the method may further include discharging from the kiln a residue containing processed agglomerates and heating the discharged, processed agglomerates and releasing fluorine therefrom. The released fluorine is reacted with reactive silica to yield fluorosilicic acid and the fluorosilicic acid collected.

In a further integration, the method may include forming the feed agglomerates with phosphate ore particles at least 80% of which have a particle size less than 325 mesh. The feed agglomerates may be formed with a mass of carbonaceous material particles that provides no more than the approximate theoretical carbon requirement for reduction of all phosphate in the ore.

The additional features that may be implemented in the present method may also be implemented in other embodiments herein.

As one example, a phosphorus pentoxide production method with fluorine management includes forming a reducing kiln bed with feed agglomerates below a reducing freeboard in a counter-current rotary kiln. The agglomerates contain phosphate ore particles, carbonaceous material particles, and silica particles. Kiln off gas is generated containing fluorine and phosphorus, the phosphorus being in the form of elemental phosphorus. The method includes oxidizing elemental phosphorus outside of the kiln to phosphorus pentoxide and collecting the phosphorus pentoxide as phosphoric acid containing fluorine. The fluorine in the phosphoric acid is reacted with reactive silica to yield fluorosilicic acid, the phosphoric acid being at 40-45% strength (as P₂O₅) when provided for the reaction. The fluorosilicic acid is removed from the collected phosphoric acid.

Additional features may be implemented in the present method. By way of example, approximately all phosphorus contained in the kiln off gas may be in the form of elemental phosphorus.

The method may further comprise collecting elemental phosphorus from the kiln off gas as elemental phosphorus.

The method may further comprise discharging from the kiln a residue containing processed agglomerates and heating the discharged, processed agglomerates and releasing fluorine therefrom. Separate from the reacting of the fluorine from the reducing kiln off gas, the released fluorine is reacted with reactive silica to yield additional fluorosilicic acid. The method includes collecting the additional fluorosilicic acid.

The additional features that may be implemented in the present method may also be implemented in other embodiments herein.

As one example, a phosphorus pentoxide production method with fluorine management includes forming a reducing kiln bed with feed agglomerates below a reducing freeboard in a counter-current rotary kiln. The agglomerates contain phosphate ore particles, carbonaceous material particles, and silica particles. Kiln off gas is generated containing fluorine and phosphorus, the phosphorus being in the form of elemental phosphorus. The method includes collecting elemental phosphorus from the kiln off gas as elemental phosphorus. The method also includes oxidizing elemental phosphorus outside of the kiln to phosphorus pentoxide and collecting the phosphorus pentoxide as phosphoric acid containing fluorine. The fluorine is reacted in the phosphoric acid with reactive silica to yield fluorosilicic acid and the fluorosilicic acid is removed from the collected phosphoric acid. The method further includes discharging from the kiln a residue containing processed agglomerates and heating the discharged, processed agglomerates and releasing fluorine therefrom. Separate from the reacting of the fluorine from the reducing kiln off gas, the released fluorine is reacted with reactive silica to yield additional fluorosilicic acid and the additional fluorosilicic acid is collected.

Additional features may be implemented in the present method. By way of example, approximately all phosphorus contained in the kiln off gas may be in the form of elemental phosphorus.

The additional features that may be implemented in the present method may also be implemented in other embodiments herein.

FIGS. 9-15 show a phosphorus pentoxide production system that integrates de-fluorination, oxidation of phosphorus gas, production of elemental phosphorus, and fluorine evolution control during the reduction process and could additionally integrate FSA recovery.

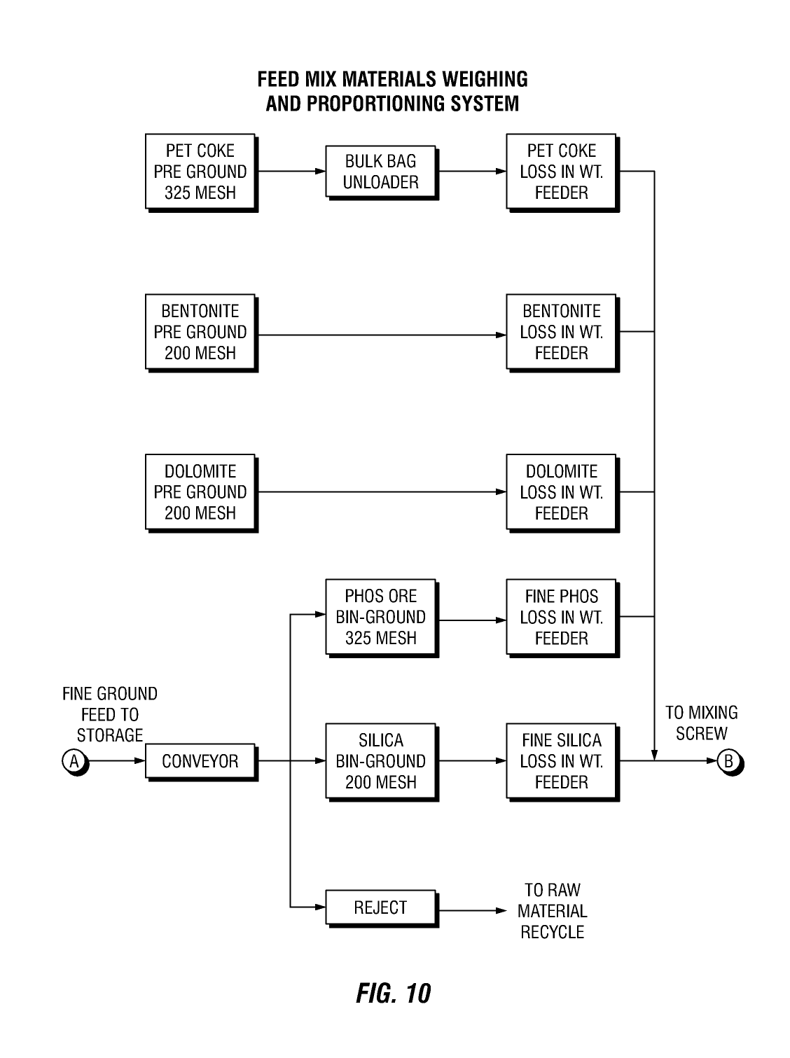

FIG. 9 shows coarse feed silica and phosphate ore processing as a part of the integrated system. FIG. 9 units prepare phosphate ore particles and silica particles for feed agglomeration. FIG. 9 continues to FIG. 10 at connector A. The rotary dryer, jaw crusher, ball mill, classifier, bag house, and conveyor (in FIG. 10) separately process the phosphate ore and silica streams one at a time since they meet separate size specifications.

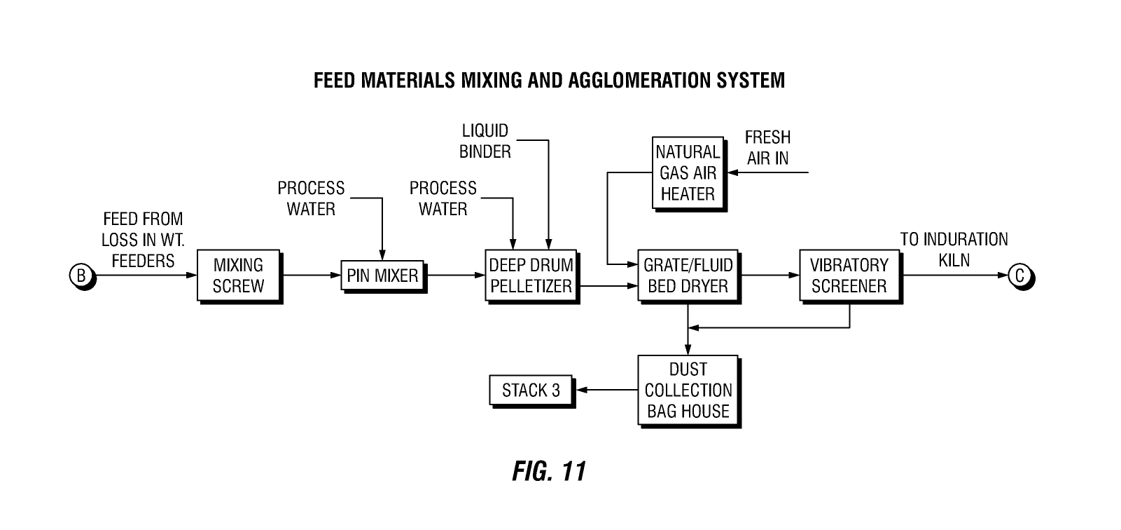

FIG. 10 shows a feed mix materials weighing and proportioning system as a part of the integrated system. FIG. 10 units select desired amounts of petroleum coke, bentonite, dolomite, phosphate ore, and silica for feed agglomeration using loss in weight feeders. FIG. 10 continues to FIG. 11 at connector B. Depending on the stream being processed in FIG. 9, the conveyor routes phosphate ore to the minus 325 mesh bin for phosphate ore or silica to the minus 200 mesh bin for silica. Using a separate, more finely ground size specification for phosphate ore enables fluorine evolution control during the reduction process, as discussed above.

FIG. 11 shows a feed materials mixing and agglomeration system as a part of the integrated system. FIG. 11 units combine ingredients for feed agglomeration and form agglomerates (pellets) with the desired shape and size. Except as otherwise described herein, composition, shape, and size of agglomerates may be according to specifications found in the four patents incorporated herein. FIG. 11 continues to FIG. 12 at connector C.

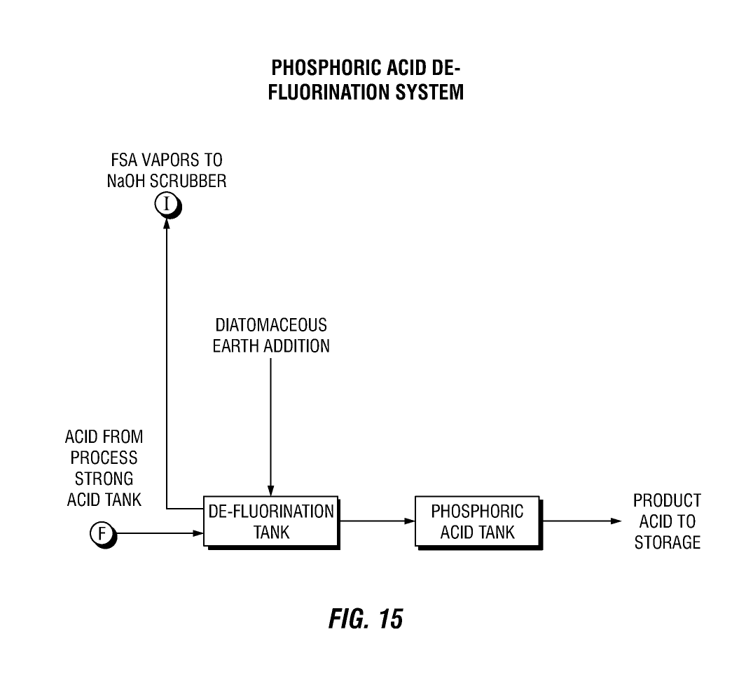

FIG. 12 shows an agglomerate feed pellets induration system as a part of the integrated system. FIG. 12 units increase crush strength of agglomerates by induration pursuant to U.S. Pat. No. 9,783,419 and process induration kiln off gas. FIG. 12 continues to FIG. 13 at connector D. Notably, induration kiln off gas is comingled with contents of the gas vent from the strong acid tank (FIG. 13) via connector G and with contents of the gas vent from the de-fluorination tank (FIG. 15) via connector I. Accordingly, the FIG. 12 system processes gas from all three sources.

FIG. 13 shows an agglomerate feed pellets reduction system as a part of the integrated system. FIG. 13 units reduce phosphate in agglomerates and extract phosphorus by the Improved Hard Process (IHP) or modifications thereof pursuant to the four patents incorporated herein. FIG. 13 units also collect the phosphorus as phosphoric acid and process reduction kiln off gas. FIG. 13 units further cool and store processed agglomerates (J-ROX®). FIG. 13 continues to FIG. 14 at connector E. FIG. 13 also continues to FIG. 15 at connector F.

Notably, reduction kiln off gas supplied to the elemental phosphorus condenser (FIG. 14) returns to the system of FIG. 13 via connector H for further processing. Accordingly, the FIG. 13 system allows either, a) oxidizing elemental phosphorus outside of the kiln to phosphorus pentoxide and collecting the phosphorus pentoxide as phosphoric acid, or b) collecting elemental phosphorus from the kiln off gas as elemental phosphorus, or c) both a) and b).

One process selection includes bypassing the elemental phosphorus condenser so that approximately all elemental phosphorus is oxidized outside of the kiln. Another process selection includes routing all kiln off gas directly to the elemental phosphorus condenser and returning off gas to the oxidizer containing residual phosphorus, if any, not collected by the condenser. A further process selection includes routing a first part of the kiln off gas directly to the oxidizer and routing a second part of the kiln off gas directly to the elemental phosphorus condenser, wherein residual phosphorus, if any, might be returned in off gas to the oxidizer.

Although not shown in FIG. 13, the fluorosilic acid recovery system of FIG. 16 could be inserted between the reduction kiln and water deluge cooler. The insertion could be accomplished by the FIG. 16 system receiving processed agglomerates from the reduction kiln and supplying stripped agglomerates from the recovery kiln to the water deluge cooler.

FIG. 14 shows an elemental phosphorus condensation and recovery system as a part of the integrated system. FIG. 14 units collect and store elemental phosphorus and treat condensate water containing HF for subsequent management in a flue gas desulfurization (FGD) pond. FIG. 14 returns to FIG. 13 at connector H.

FIG. 15 shows a phosphoric acid de-fluorination system as a part of the integrated system. FIG. 15 units remove fluorine from phosphoric acid and store the product. FIG. 15 continues to FIG. 12 at connector I. FIG. 7 provides a possible, more detailed example of the system in FIG. 15.

The inventors expressly contemplate that the various options described herein for individual methods and systems are not intended to be so limited except where incompatible. That is, the features and benefits of individual methods herein may also be used in combination with systems and other methods described herein even though not specifically indicated elsewhere. Similarly, the features and benefits of individual systems herein may also be used in combination with methods and other systems described herein even though not specifically indicated elsewhere.

In compliance with the statute, the embodiments have been described in language more or less specific as to structural and methodical features. It is to be understood, however, that the embodiments are not limited to the specific features shown and described. The embodiments are, therefore, claimed in any of their forms or modifications within the proper scope of the appended claims appropriately interpreted in accordance with the doctrine of equivalents.

TABLE OF REFERENCE NUMERALS FOR FIGURES

600 reduction kiln oxidizer system
602 supply duct to hydration tower
604 exhaust duct from carbo-thermal reduction kiln
606 gas flow direction
608 high temperature refractory lining
610 kiln exhaust oxygen sensor
612 metered oxygen inlet
614 oxidizer discharge oxygen sensor
700 phosphoric acid de-fluorination system
702 phosphoric acid inlet
704 reaction tank
706 agitator
708 diatomaceous earth feeder
710 motor
712 temperature indicator
714 pressure indicator
716 FSA vapor vent
718 pump suction line
720 valve
722 sample port
724 pump
726 pressure relief valve
728 pump discharge line
730 pressure relief line
732 heating exchanger
734 tank return line
736 valve
738 valve
740 pressure indicator
742 temperature indicator
744 pressure indicator
746 temperature indicator
748 oil heater
750 exchanger inlet line
752 valve
754 cooling exchanger
756 exchanger discharge line
758 temperature indicator
760 filter
762 filter discharge line
764 pressure indicator
766 cooling water inlet
768 hot water return
770 product acid storage tank
772 heater supply line
774 heater inlet line
776 valve
778 valve

What is claimed is:

1. A phosphorus pentoxide production method with fluorine management comprising:
forming a reducing kiln bed with feed agglomerates in a counter-current rotary kiln, the agglomerates containing phosphate ore particles, carbonaceous material particles, and silica particles;
generating kiln off gas containing fluorine and phosphorus, the phosphorus being in the form of elemental phosphorus and/or phosphorus pentoxide;
collecting the phosphorus from the kiln off gas as phosphoric acid containing fluorine;
reacting the fluorine in the phosphoric acid with reactive silica to yield fluorosilicic acid; and
removing the fluorosilicic acid from the collected phosphoric acid.

2. The method of claim 1, wherein the phosphoric acid is at 40-45% strength (as P₂O₅) when provided for the reaction of fluorine with reactive silica.

3. The method of claim 2:
wherein the reaction of the fluorine comprises combining and agitating the phosphoric acid containing fluorine and the reactive silica in a de-fluorination reaction tank; and
wherein the removal of the fluorosilicic acid comprises heating the contents of the tank during the agitation; and
further comprising the reacting, agitating, and heating causing release of fluorosilic acid vapor from the phosphoric acid and evaporation of water from the phosphoric acid, which concentrates the phosphoric acid to greater than 45% strength (as P₂O₅).

4. The method of claim 1, wherein:
the feed agglomerates in the reducing kiln bed are below a reducing freeboard;
the phosphorus in the kiln off gas is in the form of elemental phosphorus; and
the method further comprises:
either, oxidizing elemental phosphorus outside of the kiln to phosphorus pentoxide, wherein the collecting of the phosphorus from the kiln off gas comprises collecting the phosphorus pentoxide as phosphoric acid containing fluorine;
or, collecting elemental phosphorus from the kiln off gas as elemental phosphorus in addition to the collecting of the phosphorus from the kiln off gas as phosphoric acid containing fluorine;
or, both.

5. The method of claim 4, wherein approximately all phosphorus contained in the kiln off gas is in the form of elemental phosphorus.

6. The method of claim 1, wherein:
the feed agglomerates in the reducing kiln bed are below a reducing freeboard;
the phosphorus in the kiln off gas is in the form of elemental phosphorus; and
the method further comprises:
oxidizing elemental phosphorus outside of the kiln to phosphorus pentoxide, wherein the collecting of the phosphorus from the kiln off gas comprises collecting the phosphorus pentoxide as phosphoric acid containing fluorine.

7. The method of claim 1, wherein:
the feed agglomerates in the reducing kiln bed are below a reducing freeboard;
the phosphorus in the kiln off gas is in the form of elemental phosphorus; and
the method further comprises:
collecting elemental phosphorus from the kiln off gas as elemental phosphorus in addition to the collecting of the phosphorus from the kiln off gas as phosphoric acid containing fluorine.

8. The method of claim 1, wherein:
the feed agglomerates in the reducing kiln bed are below a reducing freeboard;
the phosphorus in the kiln off gas is in the form of elemental phosphorus; and
the method further comprises:
oxidizing elemental phosphorus outside of the kiln to phosphorus pentoxide, wherein the collecting of the phosphorus from the kiln off gas comprises collecting the phosphorus pentoxide as phosphoric acid containing fluorine; and
collecting elemental phosphorus from the kiln off gas as elemental phosphorus in addition to the collecting of the phosphorus from the kiln off gas as phosphoric acid containing fluorine.

9. The method of claim 1, further comprising:
discharging from the kiln a residue containing processed agglomerates;
heating the discharged, processed agglomerates and releasing fluorine therefrom;
separate from the reacting of the fluorine from the reducing kiln off gas, reacting the released fluorine with reactive silica to yield additional fluorosilicic acid; and
collecting the additional fluorosilicic acid.

10. The method of claim 1, further comprising forming the feed agglomerates with phosphate ore particles at least 80% of which have a particle size less than 325 mesh and with a mass of carbonaceous material particles that provides no more than the approximate theoretical carbon requirement for reduction of all phosphate in the ore.

11. A phosphorus pentoxide production method with fluorine management comprising:
forming a reducing kiln bed with feed agglomerates below a reducing freeboard in a counter-current rotary kiln, the agglomerates containing phosphate ore particles, carbonaceous material particles, and silica particles;
generating kiln off gas containing phosphorus in the form of elemental phosphorus; and
either, oxidizing elemental phosphorus outside of the kiln to phosphorus pentoxide and collecting the phosphorus pentoxide as phosphoric acid;
or, collecting elemental phosphorus from the kiln off gas as elemental phosphorus;
or, both.

12. The method of claim 11, wherein approximately all phosphorus contained in the kiln off gas is in the form of elemental phosphorus.

13. The method of claim 11, wherein elemental phosphorus is oxidized outside of the kiln to phosphorus pentoxide and the phosphorus pentoxide is collected as phosphoric acid.

14. The method of claim 11, wherein elemental phosphorus from the kiln off gas is collected as elemental phosphorus.

15. The method of claim 11, wherein:
elemental phosphorus is oxidized outside of the kiln to phosphorus pentoxide and the phosphorus pentoxide is collected as phosphoric acid; and
elemental phosphorus from the kiln off gas is collected as elemental phosphorus.

16. The method of claim 11 further comprising:
controlling composition of the reducing freeboard such that the kiln off gas entering the oxidizer contains less than 0.05% oxygen; and
controlling the operation of the oxidizer such that the kiln off gas exiting the oxidizer contains greater than 1.0% oxygen.

17. The method of claim 11, further comprising:
discharging from the kiln a residue containing processed agglomerates;
heating the discharged, processed agglomerates and releasing fluorine therefrom;
reacting the released fluorine with reactive silica to yield fluorosilicic acid; and
collecting the fluorosilicic acid.

18. The method of claim 11, further comprising forming the feed agglomerates with phosphate ore particles at least 80% of which have a particle size less than 325 mesh and with a mass of carbonaceous material particles that provides no more than the approximate theoretical carbon requirement for reduction of all phosphate in the ore.

19. A phosphorus pentoxide production method with fluorine management comprising:
forming a reducing kiln bed with feed agglomerates in a counter-current rotary kiln, the agglomerates containing phosphate ore particles, carbonaceous material particles, and silica particles;
generating kiln off gas containing fluorine and phosphorus, the phosphorus being in the form of elemental phosphorus and/or phosphorus pentoxide;
discharging from the kiln a residue containing processed agglomerates;
heating the discharged, processed agglomerates and releasing fluorine therefrom;
reacting the released fluorine with reactive silica to yield fluorosilicic acid; and
collecting the fluorosilicic acid.

20. The method of claim 19 wherein the heating of the discharged, processed agglomerates comprises heating to a temperature from 1350° to 1400° C. and maintaining the temperature for at least 20 minutes.

21. A phosphorus pentoxide production method with fluorine management comprising:
forming a reducing kiln bed with feed agglomerates below a reducing freeboard in a counter-current rotary kiln, the agglomerates containing phosphate ore particles, carbonaceous material particles, and silica particles;
generating kiln off gas containing fluorine and phosphorus, the phosphorus being in the form of elemental phosphorus;
oxidizing elemental phosphorus outside of the kiln to phosphorus pentoxide and collecting the phosphorus pentoxide as phosphoric acid containing fluorine;
reacting the fluorine in the phosphoric acid with reactive silica to yield fluorosilicic acid, the phosphoric acid being at 40-45% strength (as P₂O₅) when provided for the reaction; and
removing the fluorosilicic acid from the collected phosphoric acid.

22. The method of claim 21, wherein approximately all phosphorus contained in the kiln off gas is in the form of elemental phosphorus.

23. The method of claim 21 further comprising collecting elemental phosphorus from the kiln off gas as elemental phosphorus.

24. The method of claim 21 further comprising:
discharging from the kiln a residue containing processed agglomerates;
heating the discharged, processed agglomerates and releasing fluorine therefrom;
separate from the reacting of the fluorine from the reducing kiln off gas, reacting the released fluorine with reactive silica to yield additional fluorosilicic acid; and
collecting the additional fluorosilicic acid.

25. A phosphorus pentoxide production method with fluorine management comprising:
forming a reducing kiln bed with feed agglomerates below a reducing freeboard in a counter-current rotary kiln, the agglomerates containing phosphate ore particles, carbonaceous material particles, and silica particles;
generating kiln off gas containing fluorine and phosphorus, the phosphorus being in the form of elemental phosphorus;
collecting elemental phosphorus from the kiln off gas as elemental phosphorus;
oxidizing elemental phosphorus outside of the kiln to phosphorus pentoxide and collecting the phosphorus pentoxide as phosphoric acid containing fluorine;
reacting the fluorine in the phosphoric acid with reactive silica to yield fluorosilicic acid;
removing the fluorosilicic acid from the collected phosphoric acid;
discharging from the kiln a residue containing processed agglomerates;
heating the discharged, processed agglomerates and releasing fluorine therefrom;
separate from the reacting of the fluorine from the reducing kiln off gas, reacting the released fluorine with reactive silica to yield additional fluorosilicic acid; and
collecting the additional fluorosilicic acid.

26. The method of claim 25, wherein approximately all phosphorus contained in the kiln off gas is in the form of elemental phosphorus.

27. A phosphorus pentoxide production system with fluorine management comprising:
a rotary reduction kiln configured to provide a kiln bed of feed agglomerates flowing counter-current to a kiln freeboard and to produce kiln off gas containing reduction products from the kiln bed;
a phosphorus scrubbing system configured to receive the kiln off gas and to produce phosphoric acid; and
a de-fluorination system configured to receive phosphoric acid from the phosphorus scrubbing system and to remove fluorine, the de-fluorination system including a de-fluorination reaction tank, a silica feeder configured to add reactive silica to the de-fluorination reaction tank, and a fluorosilicic acid vapor vent from the de-fluorination reaction tank.

28. The system of claim 27, wherein:
when the agglomerates contain phosphate ore particles, carbonaceous material particles, and silica particles, the reduction kiln generates kiln off gas containing fluorine and phosphorus, the phosphorus being in the form of elemental phosphorus and/or phosphorus pentoxide;
when the kiln off gas contains fluorine and phosphorus pentoxide, the scrubbing system collects the phosphorus pentoxide from the kiln off gas as phosphoric acid containing fluorine;
when the phosphoric acid and reactive silica are reacted in the de-fluorination reaction tank, the fluorine is removed as fluorosilicic acid vapor via the vent.

29. The system of claim 27, further comprising:
an oxidizer outside of the reduction kiln configured to receive and to oxidize elemental phosphorus from the kiln off gas; and
an elemental phosphorus condenser configured to receive and to collect elemental phosphorus from the kiln off gas and to provide uncollected elemental phosphorus to the oxidizer.

30. The system of claim 27, further comprising:
a fluorine recovery kiln configured to receive a residue containing processed agglomerates discharged from the reduction kiln and to produce kiln off gas containing released fluorine;
a fluorine scrubbing system configured to receive released fluorine and to produce hydrofluoric acid; and
a fluorine conversion system separate from the de-fluorination system and configured to receive hydrofluoric acid from the fluorine scrubbing system and to produce fluorosilicic acid, the fluorine conversion system including a fluorine reaction tank and a silica feeder configured to add reactive silica to the fluorine reaction tank.
